(19) United States
(12) Patent Application Publication
(10) Pub. No.: US 2019/0248207 A1
(43) Pub. Date: Aug. 15, 2019

(54) AIR FLAP AND A METHOD FOR PRODUCING THE AIR FLAP

(71) Applicant: Mahle International GmbH, Stuttgart (DE)

(72) Inventors: Marta Lucka-Gabor, Bietigheim-Bissingen (DE); Fritz Mundigl, Stuttgart (DE); Michael Paul, Sachsenheim (DE)

(21) Appl. No.: 16/269,552

(22) Filed: Feb. 6, 2019

(30) Foreign Application Priority Data
Feb. 13, 2018 (DE) 102018202169.4

(51) Int. Cl. B60H 1/00; F24F 13/14

(52) U.S. Cl. CPC B60H 1/00671; F24F 13/1486; B60H 2001/006; B60H 2001/00707; B60H 2001/007; F24F 13/1406

(57) ABSTRACT

An air flap for an air conditioning system of a motor vehicle may include a bearing section defining a pivot axis for mounting the air flap on a housing and at least one flap wing integrally formed on the bearing section. The at least one flap wing may extend from the pivot axis at least one of radially towards an outside and in a circumferential direction relative to the pivot axis at least in regions. At least one of the at least one flap wing and the bearing section may include an outer skin and at least one inner region delimited from the outer skin towards a respective inside. At least one of the at least one flap wing and the bearing section may be composed of a plastic. The plastic may be exclusively a foamed plastic in the at least one inner region.

### CROSS-REFERENCE TO RELATED APPLICATIONS

This application claims priority to German Application No. DE 10 2018 202 169.4, filed on Feb. 13, 2018, the contents of which are hereby incorporated by reference in its entirety.

### TECHNICAL FIELD

The invention relates to an air flap for an air conditioning system of a motor vehicle. The invention also relates to a method for producing the air flap.

### BACKGROUND

An air flap is provided in an air conditioning system for regulating the air flow in an air duct and in the closed state securely seal the air duct and in the opened state make possible an unobstructed air flow through the air duct. For the reasons mentioned, the air flap has to be torsionally rigid in order to securely seal the air duct in the closed state. Furthermore, the air flap should have a matched contour in order to minimise in the opened state the pressure drop and a noise development at the air flap. Usually, the air flap comprises at least one flap wing which on the one hand extends to a bearing defining a tilting or pivot axis at least in regions radially or in the circumferential direction. Accordingly, the air flap can for example be a one or two-legged flap, drum flap, roll flap.

The professional world always endeavours to reduce the net weight of individual components in a motor vehicle and among others also the net weight of the air flaps in the air conditioning system. To this end, the wall thickness of the flap wings is usually reduced but this results directly in the loss of the bending strength of the flap wings. For this reason, the reduction of the wall thickness or of the net weight of the bearing of the air flap is disregarded, since the same is exposed to a major workload during operation. In order to counteract the loss of the bending strength of the flap wings, the same can be additionally stiffened geometrically through ribs, corrugations or thickened portions. Disadvantageously, the air flow in the air duct is negatively influenced by ribs, corrugations and thickened portions on the flap wings. In particular, a loud noise in the air duct can develop on the fully or partly opened air flap because of this. In addition, the net weight of the air flap stiffened in such a manner significantly increases with increasing dimensions of the flap wings.

Other solutions for reducing the net weight of the air flaps are also known already. In DE 10 2012 209 603 A1 and DE 44 14 483 A1, air flaps are described for example which have a stiff framework covered by a light material. By way of the framework, the bending strength of the flap wings can be increased and the covering makes possible an air-tight lining of the framework. EP 2 072 297 A1 describes an air flap whose the flap wings have a drop-shaped profile. This serves to particularly improve the pressure drop and the noise development in the air duct. From DE 198 14 953 A1 an air flap is known, in which a framework is over-moulded with a foam material. Here, too, the framework is designed to have a good bending strength in order to achieve the bending strength required for the flap wings. Disadvantageously, such air flaps have to be elaborately produced in multiple stages, which involves major costs.

As standard, the air flaps are produced by an injection moulding method from a plastic—for example polypropylene. Following this, a sealing lip—for example consisting of a thermoplastic elastomer—can be additionally injection moulded onto the air flap. The air flaps produced in this manner are subject to warpage which increases with increasing dimensions of the flap wings. The defects of the sealing of the air duct resulting from this have to be offset by the matched shape of the sealing lip or the flap wings, which in turn can result in a major noise development in the air duct. For producing the hybrid components with a reduced net weight, the injection moulding method with a negative stroke is known from DE 10 2014 208 421 A1. There, a blowing agent is admixed to a plastic melt and a component mould filled with the plastic melt enlarged by a negative stroke of mould parts. Because of this, the plastic melt is foamed in the component mould and the wall thickness as well as the bending strength of the hybrid component increased with a net weight remaining. However, such an injection moulding method is not directly usable for producing an air flap for an air duct because of a high complexity of the components and, in particular, flap bearings.

In summary, a reduction of the net weight of the air flap according to the known prior art involves major design and production expenditure combined with high costs.

### SUMMARY

The object of the invention therefore is to state an improved or at least alternative embodiment for an air flap of the generic type with which the described disadvantages can be overcome. A further object of the invention is to provide a method for producing the air flap.

According to the invention, this object is solved through the subject of the independent claim(s). Advantageous embodiments are subject of the dependent claim(s).

The present invention is based on the general idea of reducing the net weight in an air flap for an air conditioning system of a motor vehicle in regions, with a bending strength remaining the same. The air flap for an air conditioning system of a motor vehicle comprises a bearing section defining a pivot axis of the air flap for mounting the air flap on a housing and at least one flap wing. The at least one flap wing is integrally formed on the bearing section and extends from the pivot axis of the air flap at least in regions radially to the outside and/or in the circumferential direction. According to the invention, the at least one flap wing and/or the bearing section has an outer skin and at least one inner region delimited from the outer skin towards the inside, which merge into one another. The at least one flap wing and/or the bearing section are formed from a plastic, wherein the plastic is exclusively foamed in the inner region.

The air flap can comprise multiple inner regions, which are delimited by the outer skin towards the outside. Both the outer skin and also at least one inner region are produced from the same plastic and merely differ in their density. The outer skin has a density corresponding to the unfoamed plastic and in the at least one inner region the density—also varying in a region—is reduced according to a foaming factor. In this advantageous way the net weight of the air flap can be reduced with no reduction or a minor reduction of the wall thickness and the bending strength of the air flap retained. In particular, the net weight is reducible only on the flap wings without the density and the bending strength of the bearing section being influenced. Furthermore, the air flap is additionally stiffened by the outer skin and the surface quality of the air flap improved. The air flap can, for example, consist of polypropylene, polyamide or polyolefin with a suitable for example mineral addition for foaming the plastic.

Advantageously, a density of the foamed plastic in the at least one inner region can be lower by a foaming factor between 1.1 and 4 than a density of the plastic in the outer skin. The foaming factor between 1.1 and 4 makes possible an increase in volume by 10% to 300% and accordingly a density reduction. Preferably, the foaming factor amounts to approximately 2 and makes possible the volume increase by 100% and the density reduction by 50%. Advantageously, the air flap can comprise at least two inner regions, wherein foaming factors of the foamed plastic in these inner regions deviate from one another. Accordingly, two inner regions can be formed for example in the at least one flap wing which have a density deviating from one another and a net weight deviating from one another.

In a further development of the air flap according to the invention it is advantageously provided that on a bearing side of the bearing section an axially projecting bearing element is integrally formed. The bearing element can be arranged in a bearing opening of the housing and the air flap rotatably mounted about the pivot axis on the housing because of this. Alternatively, an axially extending bearing opening can be formed on a bearing side of the bearing section. In the bearing opening, an axially projecting bearing element of the housing can then be arranged and the air flap be rotatably mounted about the pivot axis on the housing because of this. On the bearing side, the air flap is rotatably mounted passively. For actively mounting the air flap, an axially extending mounting space can be formed on a receiving side of the bearing element section and in the mounting space an output element of the air flap can be non-rotatably fixed on one side. On the other side, the output element can be rotatably arranged in a receiving opening of the housing and the air flap rotatably mounted about the pivot axis on the housing because of this. On the output element, a pivot or tilting drive—for example an actuator—can be arranged which pivots the output element and because of this the air flap that is non-rotably fixed on the output element and because of this opens and closes the air duct.

For the non-rotatable fixing of the output element in the mounting space at least one radial engagement lug can be formed on the output element and at least one radial engagement opening in the mounting space. The engagement lug can then engage in the engagement opening and because of this the output element can be non-rotatably fixed in the mounting space. Alternatively or additionally, at least one axially extending groove or tongue can be formed in the mounting space and on the output element a complementarily formed tongue or groove be formed. The respective tongue and the respective groove can then be in engagement in the circumferential direction to the pivot axis and because of this the output element in the mounting space can be non-rotatably fixed.

Advantageously it can be provided that on the at least one flap wing an interference structure with multiple mouldings and/or with multiple recesses is formed. The multiple mouldings and/or the multiple recesses of the interference structure can be arranged regularly or irregularly on the at least one flap wing. In particular, a noise development on the air flap in a slightly opened state can be reduced in this way without increasing the net weight of the air flap.

In an advantageous further development of the air flap according to the invention it is provided that the at least one flap wing has a flat radial region adjoining the bearing section and a flat deflection region adjoining the radial region, wherein the deflection region adjoins the radial region at a bending angle. In particular, air can be deflected in the air duct with the opened air flap in this way, and because of this a favourable air flow in the air duct achieved. In order to be able to seal the air duct, an axially extending sealing lip can be fixed in an edge region of the at least one flap wing facing away from the bearing section. Here, the sealing lip is fixed preferably in a material-bonded manner by injection moulding and/or is fixed in a form-fitting manner by engaging on the at least one flap wing.

In summary, the air flap according to the invention has a reduced net weight with a high bending strength. Furthermore, additional reinforcement structures such as for example ribs or corrugations are obsolete with the air flap according to the invention so that the undesirable noise development and the complexity of the air flap are reduced.

The invention also relates to a method for producing an air flap for an air conditioning system of a motor vehicle. In the method, a closed cavity is initially formed from at least two mould parts and the formed cavity is filled with a melted plastic charged with a blowing agent. The filled cavity is enlarged by moving the mould parts or mould segments of at least one of the mould parts so that in the enlarged cavity an under pressure is created and a foam formation initiated in the melted plastic. Following a solidification of the plastic, the enlarged cavity is opened for removing the produced air flap. According to the invention, the air flap described above is described by the method. The air flap described above can be produced by the method with a reduced net weight in one production step. Here, the air flap does not have any additional stiffening structures and an undesirable noise development on the air flap can be advantageously prevented.

In the method according to the invention, the mould parts or the individual mould segments of one of the mould parts can be moved in such a manner that the air flap described above is produced with the at least one flap wing and the bearing section. In the method, an outer skin and at least one inner region that is delimited from the outer skin towards the inside is formed in the at least one flap wing and/or in the bearing section, which integrally merge into one another. The outer skin is formed from the plastic and the at least one inner region is formed from the foamed plastic. Both the outer skin and also the at least one inner region are produced from the same plastic and merely differ in their density. Accordingly, the one mould part cannot be moved and the other mould part or one or some of the mould segments of the other mould part can be moved. On the moved mould segments, the outer skin is formed from the plastic that is solidified and not foamed on the mould surfaces of the mould segments and by way of a negative stroke of the mould segments, the inner regions that are delimited from the outer skin moulded from the foamed plastic. On the unmoved mould segments, the plastic is not foamed and exclusively the outer skin formed.

For example with the air flap having two flap wings, the mould segments forming the two flap wings can be moved and in the two flap wings the inner regions delimited by the outer skin formed from the foamed plastic because of this. The mould segment forming the bearing section of the air flap cannot be moved so that the bearing section is formed from the unfoamed plastic. Alternatively, the mould segment forming the bearing section of the air flap can be moved with a smaller negative stroke than the mould segments forming the two flap wings so that the inner region in the bearing section is foamed to a higher density than in the inner regions of the flap wings. Alternatively or additionally, the mould segments forming the two flap wings can be moved with a deviating negative stroke.

Advantageously it can be provided that the plastic in the at least one inner region of the at least one flap wing and/or of the bearing section is chemically or mechanically foamed to a density which is lower by a foaming factor between 1.1 and 4 than a density of the plastic in the outer skin. The foaming factor between 1.1 and 4 makes possible a volume increase by 10% to 300% and accordingly a density reduction. Preferably, the foaming factor is approximately 2 and makes possible the volume increase in the inner region by 100% and a corresponding density reduction. Advantageously, the plastic in the inner regions can be chemically or mechanically foamed to a deviating density in that for example the mould segments forming the two inner regions are moved with a deviating negative stroke. In order to configure the bearing section of the air flap so as to be stable, the plastic in the inner region of the bearing section can be foamed by a more deviating foaming factor than the plastic in the at least one inner region of the at least one flap wing. Alternatively, the plastic in the bearing section cannot be foamed.

Advantageously, the mould parts and/or the individual mould segments can be temperature-controlled to a deviating process temperature. A foaming factor of the plastic in the at least one inner region of the at least one flap wing and/or of the bearing section can be adapted by a deviating process temperature. In particular, the thickness of the outer skin defining the inner regions can be adapted in this way. Accordingly, the mould segment for example forming the bearing section of the air flap or a region of the mould part forming the bearing section of the air flap can be cooled so that a foaming in the bearing section is partly or completely prevented even during a negative stroke of the neighbouring mould segment or of the neighbouring mould part. In this way, the bearing section can have an same bending strength and an same quality as with a compactly injection moulded air flap. Furthermore, the inner regions can be formed with a deviating density within the air flap even with an same negative stroke of the mould parts and/or of the mould segments of the mould parts.

In order to be able to seal the air duct, the axially extending sealing lip can be injection moulded on in a material-bonded manner and/or can be engaged in a form-fitting manner following the removal of the air flap from the cavity in the edge region of the at least one flap wing facing away from the bearing section. The air flap can be produced for example from polypropylene, polyamide or polyolefin with a suitable for example mineral additive for promoting the foaming of the plastic and the sealing lip for example from a thermoplastic elastomer.

In summary, the air flap can be produced with the method according to the invention with a reduced net weight and a high bending strength in one process step in a simplified and cost-saving manner. In the produced air flap, additional reinforcing structures such as for example ribs or corrugations can be omitted and an undesirable noise development on the air flap advantageously prevented because of this. Corrugations and other contours for suppressing the noise development in the case of an only slightly opened air flap however can be realised without problems.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawing and are explained in more detail in the following description, wherein same reference numbers relate to same or similar or functionally same components.

### BRIEF DESCRIPTION OF THE DRAWINGS

It shows, in each case schematically

FIG. 1 shows a sectional view of an air flap according to the invention with an outer skin and a foamed inner region;

FIG. 2 shows a sectional view of an air flap according to the invention with an outer skin and two foamed inner regions;

FIG. 3 shows a sectional view of a bearing section of an air flap according to the invention;

FIG. 4 shows a sectional view of an output element of an air flap according to the invention;

FIG. 5 shows a sectional view of an output element of an air flap according to the invention engaged in a mounting space of a bearing section.

### DETAILED DESCRIPTION

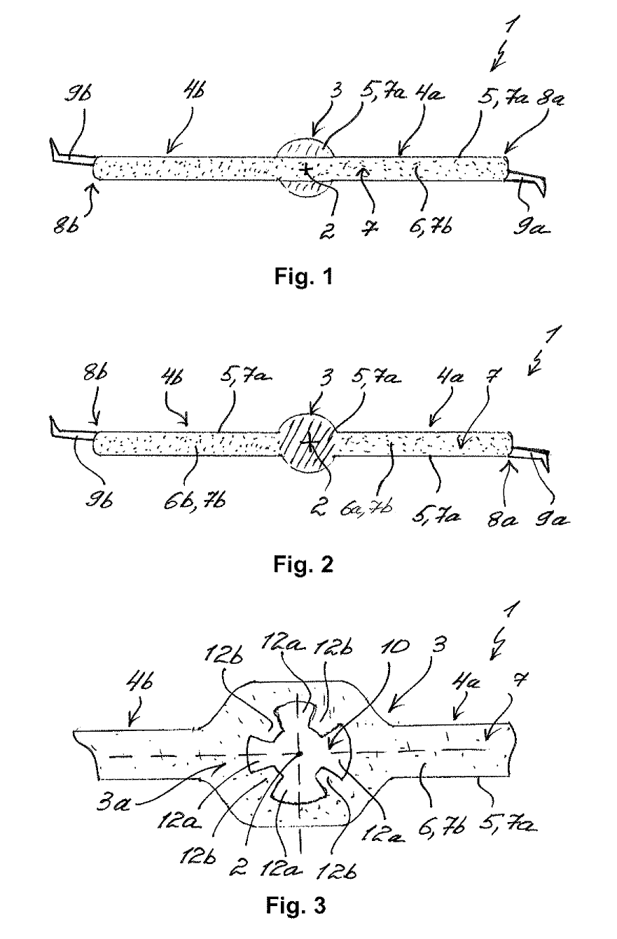

FIG. 1 shows a sectional view of an air flap 1 for an air conditioning system of a motor vehicle according to the invention. The air flap 1 comprises a bearing section 3 defining a pivot axis 2 of the air flap 1 and two same flap wings 4a and 4b. The flap wings 4a and 4b are integrally formed on the bearing section 3 and extend from the pivot axis 2 of the air flap 1 radially to the outside. The flap wings 4a and 4b and the bearing section 3 have an outer skin 5 and an inner region 6 that is delimited from the outer skin 5 towards the inside. The outer skin 5 and the inner region 6 merge integrally into one another and are produced from a same plastic 7, wherein the plastic 7 is exclusively foamed in the inner region 6. In the edge regions 8a and 8b of the flap wings 4a and 4b facing away from the bearing section 3, the air flap 1 furthermore comprises axially extending sealing lips 9a and 9b. In this exemplary embodiment, the sealing lip 9a and 9b is injection moulded onto the flap wings 4a and 4b.

FIG. 2 shows a lateral view of the air flap 1 according to the invention in a deviating configuration. Here, the air flap 1 comprises two inner regions 6a and 6b in the two flap wings 4a and 4b. The inner regions 6a and 6b are arranged in the flap wings 4a and 4b and delimited towards the outside by the outer skin 5. The outer skin 5 and the inner regions 6a and 6b merge integrally into one another and are produced from the same plastic 7, wherein the plastic 7 is exclusively foamed in the inner regions 6a and 6b. In the bearing section 3, which separates the two flap wings 4a and 4b from one another, the air flap 1 does not have an inner region, so that the bearing section 3 is configured in a particularly stiff and sturdy manner in order to make possible an exact mounting of the air flap 1 in an air duct of the air conditioning system. Alternatively, axial outside regions of the bearing section 3 cannot be foamed and an axial middle region can be foamed—and an inner region formed. The foamed region of the bearing section 3 follows the non-foamed regions of the bearing section 3 axially on both sides. On the non-foamed regions of the bearing section 3 the air flap can then be mounted in the air duct. Here, too, the air flap 1 comprises the injection-moulded sealing lip 9a and 9b each in the edge regions 8a and 8b of the flap wings 4a and 4b.

The air flaps 1 in FIG. 1 and in FIG. 2 can consist for example of polypropylene, polyamide or polyolefin with a suitable for example mineral additive for foaming the plastic 7 and the sealing lips 9a and 9b can consist for example of a thermoplastic elastomer. The outer skin 5 is formed from the non-foamed plastic 7a and the inner region 6 as well as the inner regions 6a and 6b from the foamed plastic. The outer skin 5 has the density corresponding to the non-foamed plastic 7a and the density of the foamed plastic 7b in the inner region 6 as well as in the inner regions 6a and 6b is reduced according to a foaming factor. The foaming factor can be between 1.1 and 4 and make possible a density reduction by 10% to 75% in the respective inner regions 6 as well as 6a and 6b. In this advantageous manner, the air flap 1 has a reduced net weight with no or a minor reduction of the wall thickness and the bending strength of the flap wings 4a and 4b as well as of the bearing section 3.

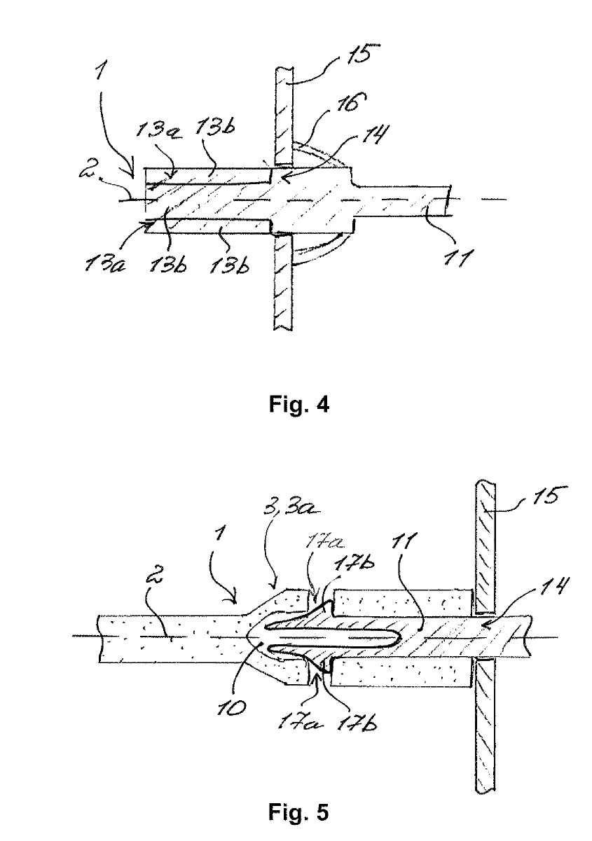

FIG. 3 shows a bearing section 3 of the air flap 1 according to the invention on a receiving side 3a. In the bearing section 3, an axially extending mounting space 10 is formed, in which an output element 11 can be non-rotatably fixed. A sectional view of the corresponding output element 11 is shown in FIG. 4. For non-rotatably fixing the output element 11 in the mounting space 10, multiple grooves 12a and tongues 12b extending axially are formed in the mounting space 10. On the output element 11, multiple complementarily formed tongues 13b and grooves 13a are moulded. The respective grooves 12a and 13a and the respective tongues 12b and 13b are in engagement in the circumferential direction to the pivot axis 2 and the output element 11 is non-rotatably fixed in the mounting space 10 on one side. On the other side, the output element 11 is rotatably arranged in a receiving opening 14 of a housing 15. A circumferential seal 16 seals the receiving opening 14 in the housing 15 towards the outside. On the output element 11, a pivot or tilting drive can be arranged in order to pivot or tilt the output element 11 and because of this the air flap 1 that is non-rotatably fixed on the output element 11 about the pivot axis 2.

FIG. 5 shows a sectional view of the air flap 1 according to the invention with the alternatively configured bearing section 3 and the alternatively configured output element 11. Here, the output element 11 is non-rotatably engaged in the mounting space 10 of the bearing section 3. To this end, radial engagement openings 17a are moulded in the mounting space 10 and radially projecting engagement lugs 17b on the output element 11. The engagement lugs 17b are engaged in the engagement openings 17a and the output element 11 non-rotatably fixed in the mounting space 10 on one side. Analogously to the output element in FIG. 4, the output element 11 in this exemplary embodiment is rotatably fixed in the receiving opening 14 of the housing 15 on the other side and can be pivoted or tilted with the air flap 1 about the pivot axis 2 by a pivot or tilting drive.

In summary, the air flap 1 according to the invention has a reduced net weight with a high bending strength. Furthermore, additional reinforcement structures such as for example ribs or corrugations are not required with the air flap 1 according to the invention so that the undesirable noise development and the complexity of the air flap 1 are reduced.

1. An air flap for an air conditioning system of a motor vehicle, comprising:
a bearing section defining a pivot axis for mounting the air flap on a housing;
at least one flap wing integrally formed on the bearing section and extending from the pivot axis at least one of radially towards an outside and in a circumferential direction relative to the pivot axis at least in regions;
at least one of the at least one flap wing and the bearing section including an outer skin and at least one inner region delimited from the outer skin towards a respective inside; and
wherein at least one of the at least one flap wing and the bearing section are composed of a plastic, and wherein the plastic is exclusively a foamed plastic in the at least one inner region.

2. The air flap according to claim 1, wherein a density of the foamed plastic in the at least one inner region is lower by a foaming factor of 1.1 to 4 than a density of a plastic in the outer skin.

3. The air flap according to claim 1, wherein the at least one inner region includes at least two inner regions, and wherein a respective foaming factor of the foamed plastic in the at least two inner regions deviate from one another.

4. The air flap according to claim 1, wherein at least one of:
on a bearing side of the bearing section an axially projecting bearing element is integrally provided, the bearing element of the bearing section arrangable in a bearing opening of the housing such that the air flap is rotatably mounted about the pivot axis on the housing when the bearing element of the bearing section is arranged in the bearing opening of the housing; and
on the bearing side of the bearing section an axially extending bearing opening is disposed, the bearing opening of the bearing section structured and arranged to receive an axially projecting bearing element of the housing such that the air flap is rotatably mounted about the pivot axis on the housing when the bearing element of the housing is arranged in the bearing opening of the bearing section.

5. The air flap according to claim 1, wherein the bearing section includes, on a receiving side of the bearing section, an axially extending mounting space and, in the mounting space, an output element is non-rotatably coupled on one side, and wherein the output element on another side is rotatably arrangable in a receiving opening of the housing such that the air flap is rotatably mounted about the pivot axis on the housing when the another side of the output element is arranged in the receiving opening.

6. The air flap according to claim 5, wherein at least one of:
the mounting space includes at least one radial engagement opening and the output element includes at least one radial engagement lug, the output element non-rotatably engaged in the mounting space via the at least one engagement opening and the at least one engagement lug; and
the mounting space includes at least one of an axially extending groove and an axially extending tongue and the output element includes at least one of a complementarily structured tongue and a complimentarily structured groove which are in engagement with one another in the circumferential direction, and wherein the output element is non-rotatably coupled in the mounting space via the at least one of the grove and the tongue and the at least one of the complimentary tongue and the complimentary groove.

7. The air flap according to claim 1, wherein:
the at least one flap wing includes an interference structure with at least one of a plurality of mouldings and a plurality of recesses; and
the at least one of the plurality of mouldings and the plurality of recesses are one of regularly and irregularly arranged on the at least one flap wing.

8. The air flap according to claim 1, wherein the at least one flap wing has a flat radial region adjoining the bearing section and a flat deflection region adjoining the radial region, and wherein the deflection region adjoins the radial region at a bending angle.

9. The air flap according to claim 1, wherein, in an edge region of the at least one flap wing facing away from the bearing section, an axially extending sealing lip is coupled in at least one of a material-bonded manner via injection moulding and a form-fitting manner via engaging.

10. A method for producing an air flap for an air conditioning system of a motor vehicle, the air flap including a bearing section defining a pivot axis for mounting the air flap on a housing and at least one flap wing integrally formed on the bearing section and extending at least one of radially away from the pivot axis and in a circumferential direction relative to the pivot axis at least in regions, at least one of the at least one flap wing and the bearing section including an outer skin and at least one inner region delimited from the outer skin towards a respective inside, at least one of the at least one flap wing and the bearing section composed of a plastic and the at least one inner region composed exclusively of a foamed plastic, the method comprising:
forming a closed cavity between two mould parts;
filling the closed cavity with a melted plastic charged with a blowing agent;
enlarging the closed cavity filled with the melted plastic via moving at least one of the two mould parts and a plurality of individual mould segments of at least one of the two mould parts such that in the closed cavity an under pressure is created and a foam formation in the melted plastic is initiated; and
opening the closed cavity and removing the air flap following a solidification of the melted plastic.

11. The method according to claim 10, further comprising one of chemically foaming and mechanically foaming the melted plastic in the at least one inner region of the at least one of the at least one flap wing and the bearing section to a density that is lower by a foaming factor of 1.1 to 4 than a density of the melted plastic in the outer skin.

12. The method according to claim 10, further comprising one of:
foaming the melted plastic in the at least one inner region of the bearing section by a deviating foaming factor than the melted plastic in the at least one inner region of the at least one flap wing; and
foaming none of the melted plastic in the bearing section.

13. The method according to claim 10, further comprising:
temperature controlling at least one of the two mould parts and the plurality of individual mould segments to a deviating process temperature; and
adapting a foaming factor of the melted plastic in the at least one inner region of the at least one of the at least one flap wing and the bearing section via the deviating process temperature.

14. The method according to claim 10, further comprising, after removing the air flap, injection moulding an axially extending sealing lip onto the at least one flap wing in an edge region of the at least one flap wing facing away from the bearing section, wherein the sealing lip is injection moulded on in at least one of a material-bonded manner and in an engaging form-fitting manner.

15. The method according to claim 10, further comprising one of chemically foaming and mechanically foaming the melted plastic in the at least one inner region of the at least one of the at least one flap wing and the bearing section to a density that is lower by a foaming factor of 2 than a density of the melted plastic in the outer skin.

16. The air flap according to claim 1, wherein a density of the foamed plastic in the at least one inner region is lower by a foaming factor of 2 than a density of a plastic in the outer skin.

17. The air flap according to claim 1, wherein:
the at least one flap wing includes an interference structure with at least one of a plurality of mouldings and a plurality of recesses; and
the at least one of the plurality of mouldings and the plurality of recesses are irregularly arranged on the at least one flap wing.

18. The air flap according to claim 1, wherein the at least one flap wing includes an interference structure with a plurality of mouldings and a plurality of recesses.

19. The air flap according to claim 1, wherein both the at least one flap wing and the bearing section include the outer skin.

20. The air flap according to claim 7, wherein, in an edge region of the at least one flap wing facing away from the bearing section, an axially extending sealing lip is coupled in at least one of a material-bonded manner via injection moulding and a form-fitting manner via engaging.
